(19) United States
(12) Patent Application Publication
(10) Pub. No.: US 2008/0232284 A1
(43) Pub. Date: Sep. 25, 2008

(54) Apparatus, method and computer program product providing semi-dynamic persistent allocation

(75) Inventors: Lars Dalsgaard, Oulu (FI); Esa M. Malkamaki, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 12/077,897

(22) Filed: Mar. 21, 2008

Related U.S. Application Data
(60) Provisional application No. 60/919,743, filed on Mar. 23, 2007.

(51) Int. Cl. H04B 7/00

(52) U.S. Cl. 370/310

(57) ABSTRACT

A network element sets up a connection with an individual user equipment UE, provides an indicator that informs that a particular resource allocation to the individual user equipment is persistent, and sends resource allocations to a plurality of user equipments that includes the particular resource allocation to the individual user equipment. The indication can be implicit in the position of the particular resource allocation within the plurality of resource allocations as arranged during the connection setup, or it may be explicit with the resource allocation such as from a bit stolen from the CRC field. The persistent allocation can be terminated in multiple ways, including overwriting with a new persistent allocation, sending an end bit or no data, or sending an improper CRC field which is arranged by an absence of both a NACK from the UE and a re-transmission from the network as a terminating condition.

### CROSS REFERENCE TO RELATED APPLICATION

This patent application claims priority under 35 U.S.C. §119(e) from U.S. Provisional Patent Application No. 60/919,743, filed Mar. 23, 2007, the disclosure of which is incorporated by reference herein in its entirety.

### TECHNICAL FIELD

The exemplary and non-limiting embodiments of this invention relate generally to wireless communications systems and, more specifically, relate to resource allocations to users of the wireless system and how those allocations are given to the users and released.

### BACKGROUND

The following abbreviations are herewith defined:

3GPP third generation partnership project

ACK acknowledge

ARQ automatic retransmission request

AT allocation table (PDCCH)

DL downlink

DRX discontinuous reception

DTX discontinuous transmission

eNB evolved nodeB (of an LTE system)

E-UTRAN evolved UTRAN (LTE or 3.9G)

GSM global system for mobile communications

HARQ hybrid automatic re-transmission request

HSDPA high speed downlink packet access

LTE long term evolution of 3GPP

MSC message sequence chart

NACK negative acknowledge

Node B base station or similar network access node

OFDM orthogonal frequency division multiplex

PDCCH packet downlink control channel

PS packet scheduler

RRC radio resource control

TTI transmission time interval

UE user equipment (e.g., mobile equipment/station)

UL uplink

UMTS universal mobile telecommunications system

UTRAN UMTS terrestrial radio access network

VoIP voice over IP (internet protocol)

Relevant to this invention is the concept of resource allocations on a common channel over which multiple users receive resources specifically allocated to only one of them. LTE is one such system that employs this concept. In LTE, the network assigns resources to UE's using the packet downlink control channel (PDCCH) (also referred to as allocation table AT). The network schedules UE's at certain points in time which are clearly defined and synchronized between the network and the various UEs being allocated. These instants in time are also referred to DRX timeout periods (from the UE point of view). This allows the UE to re-tune its receiver from its downlink data channel to the PDCCH in a manner in which it will not miss transmissions scheduled for it on either channel.

At each DRX the UE will read one or more PDCCH (this specific amount is also ‘negotiated’ or otherwise commanded by the network previously, e.g. during setup of a connection with the UE) in which the UE may then be assigned resources by the network—if needed or feasible.

One problem which has been identified in E-UTRAN resource allocation principles is the potential lack of capacity on the control channel used for resource allocation. This problem is especially evident when considering a situation where the system has a large amount of active users all generating a large amount of small data packages with tight delay constraints (e.g. VoIP, gaming etc.). In this situation the E-UTRAN system could be faced with either having a huge amount of control signaling overhead compared to the actual transferred data, or being unable to use all available resources on the air interface due to lack of addressing possibilities (not enough space in AT/PDCCH for addressing a sufficient number of UEs to allocate all available resources).

In situations of many users and small data packets the current PDCCH design does not work very efficiently and introduces at least the following two problem possibilities:
Scheduling overhead due to resource assignments in PDCCH becomes very large; and
There is no room in PDCCH for assigning all possible resources available (wasting air interface).

These problems are quite severe because having too large scheduling overhead decreases the efficiency of the system regarding actual user data throughput. Secondly—not being able to schedule all available resources on air interface due to limited space in the control channel is something that should be avoided in wireless systems where the air interface resources are seen as the scarcest.

The above problem is present when considering transmission of a large amount of frequently occurring packets (e.g. VoIP) using a dynamic scheduling principle. Some approaches to solve this problem can be generalized as follows:
Persistent scheduling (GSM like allocation handled through RRC signaling only)
Semi-persistent scheduling of VoIP for DL (cf. high speed shared channel HS-SCCH less HSDPA)
Talk-spurt based scheduling
Additional layer 1 (L1) control channel resources
Group scheduling
Semi-dynamic scheduling with group ID

Persistent scheduling is seen to be not in line with a packet based system and is not able to provide very good scheduling flexibility for the packet scheduler (PS) on the network side. Semi-persistent scheduling requires blind decoding and additional memory on the UE side. Known prior art cases for persistently allocating resources use signaling for release of those resources, which represents additional control signaling overhead as compared to true dynamic allocation. Talk-spurt based scheduling is seen to be a good candidate in general, but additional L1 signaling would be needed to indicate allocation type. Additional L1 control channel resources is an option that is seen to increase control overhead at the cost of fewer resources for user data. Group scheduling lacks the resources being allocated for individual UEs and so there is a risk that resources would be wasted by lack of being allocated as efficiently as if they were allocated on an individualized basis. The semi-dynamic scheduling with group ID also requires grouping the UEs and is seen to tend toward a less efficient allocation of the overall resources as compared to individualized allocations.

What is needed in the art is some way to efficiently allocate resources to many UEs in a cell without excessive control signaling overhead, where excessive is in relation to the actual data being sent to and from those UEs. Particularly needed is an approach that will work in LTE given the existing concern for capacity shortfalls of the PDCCH/AT noted above.

### SUMMARY

According to one exemplary embodiment of the invention is a method that includes setting up a connection with an individual user equipment, and sending resource allocations to a plurality of user equipments that comprises a particular resource allocation to the individual user equipment and an indication that the particular resource allocation is a persistent resource allocation.

According to another exemplary embodiment of the invention is an apparatus that includes a processor, a memory and a transceiver that are together configured to set up a connection with an individual user equipment and to send resource allocations to a plurality of user equipments that includes a particular resource allocation to the individual user equipment and an indication that the particular resource allocation is persistent.

According to still another exemplary embodiment of the invention is a computer readable memory embodying a program of machine-readable instructions that are executable by a digital data processor to perform actions directed toward scheduling an individual user equipment for a persistent resource allocation. In this embodiment the actions include setting up a connection with an individual user equipment, and sending resource allocations to a plurality of user equipments that comprises a particular resource allocation to the individual user equipment and an indication that the particular resource allocation is persistent.

According to another exemplary embodiment of the invention is a method that includes setting up a connection with a network element, and receiving from the network element a particular resource allocation and an indication that the particular resource allocation is persistent and storing the persistent resource allocation.

According to yet another exemplary embodiment of the invention is an apparatus that includes a processor, a memory and a transceiver that together are configured to set up a connection with a network element and to receive from the network element a particular resource allocation and an indication that the particular resource allocation is persistent and to store the persistent resource allocation in the memory.

And according to still another exemplary embodiment of the invention is a computer readable memory embodying a program of machine-readable instructions that are executable by a digital data processor to perform actions directed toward determining that a resource allocation is persistent. In this embodiment the actions include setting up a connection with a network element, and receiving from the network element a particular resource allocation and an indication that the particular resource allocation is persistent and storing the persistent resource allocation.

### BRIEF DESCRIPTION OF THE DRAWINGS

Embodiments of the invention are detailed below with particular reference to the attached drawing Figures.

FIG. 1 shows a simplified block diagram of various electronic devices that are suitable for use in practicing the exemplary embodiments of this invention.

FIGS. 2A and 2B are schematic diagrams illustrating a discontinuous reception schedule in which resource allocations are received.

FIG. 3 is a signaling diagram between user equipment and network for the case where semi-persistent allocation is used with one TTI per DRX timeout period.

FIG. 4 is similar to FIG. 3, but for the case where there are three TTIs in the DRX timeout period

FIG. 5 is a signaling diagram illustrating how a how a persistent allocation might be terminated apart from being replaced by another persistent allocation, where the DRX timeout period is one TTI.

FIG. 6 is a signaling diagram depicting three different error scenarios of terminating a persistent allocation according to a ‘lazy ending’ aspect, where the UE does not receive re-transmissions and looses the packet.

FIG. 7 is similar to FIG. 6, but showing an additional error scenario where the packet is re-transmitted but the allocated resources are wasted because the UE will not read/receive the packet.

### DETAILED DESCRIPTION

Though not limited thereto, embodiments of this invention are particularly advantageous for use in an E-UTRAN (a.k.a. LTE, 3.9G) system, and relate to scheduling of resources on the air interface. The embodiments detailed below address at least some of the problems noted above such as the situation where the scheduling control channel overhead is high due to frequent transmissions of small sizes data packets in DL/UL from multiple users.

One known solution is described at International Publication Number WO 2006/114689 A2, by inventors Esa Malkamaki and Markku Kuusela: “FIXED HS-DSCH ORE-DCH CHANNEL ALLOCATION FOR VOIP (OR HS-DSCH WITHOUT HS-SCCH/E-DCH WITHOUT E-DPCH)”. That document is hereby incorporated by reference as if attached hereto.

Since control signaling overhead should be minimized in the presence of scarce resources, embodiments of this invention relate to a persistent allocation solution, and further to an efficient way of being able to release a given persistent downlink (DL) allocation on the UE side without any need for signaling between the eNB and the UE. While the concept is described with reference to the DL, that description is by example only and not a limitation; these teachings may be readily extended to the UL as well as to other communication systems other than E-UTRAN.

This disclosure addresses the problem in two main aspects. In a first main aspect, resources are assigned to the UEs individually in a semi-persistent manner, such that the network does not need to assign resources to a specific UE if the former allocation of resources is still valid and can be re-used without changes. In a second main aspect, the UE releases its persistent allocation of resources based on a HARQ retransmission, under the conditions that the UE has been assigned a persistent allocation of resources by the eNB but the UE is not allocated in the persistent allocation. It is advantageous that these two different aspects of the invention may be used together in a communications system, but they may be used separately and distinct from one another. These two main aspects are detailed below in turn.

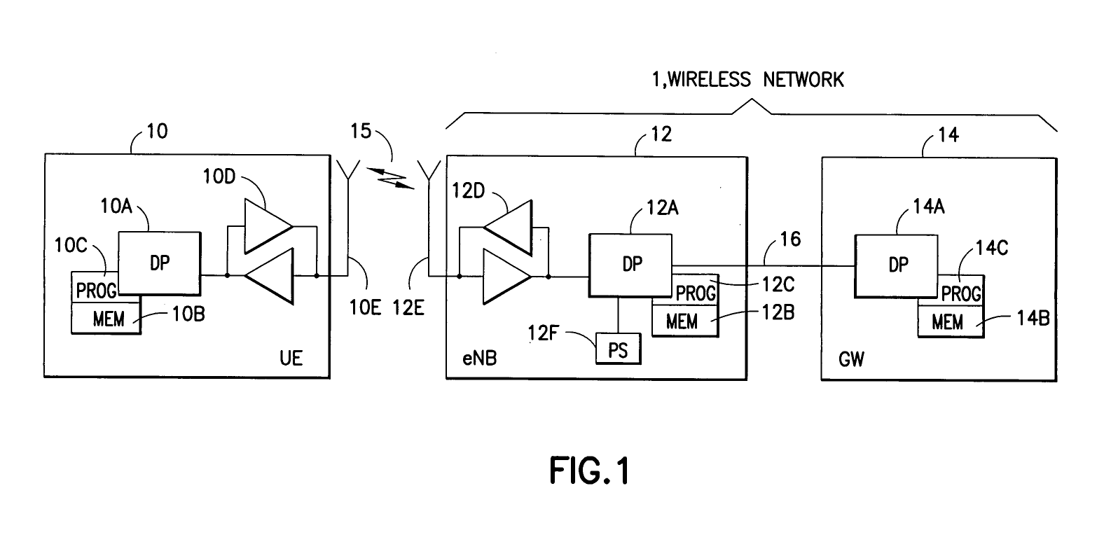

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a node B (e.g., base station or eNB) 12. The network 1 may include a higher controlling node generically shown as a gateway GW 14, which may be referred to variously as a radio network controller RNC, a user plane entity UPE, a mobility management entity MME, or a system architecture evolution gateway SAE-GW. The GW 12 represents a network node higher in the network than the eNB 12.

The UE 10 includes a data processor (DP) 10A, a memory (MEM) 10B that stores a program (PROG) 10C, and a suitable radio frequency (RF) transceiver 10D for bidirectional wireless communications with the eNB 12, which also includes a DP 12A, a MEM 12B that stores a PROG 12C, and a suitable RF transceiver 12D. The eNB 12 may be coupled via a data path 16 (e.g., Iub or S1) to the serving or other GW 14. Separate from or within the DP 12A of the eNB 12 is a packet scheduler PS 12F for scheduling user data according to embodiments detailed below. The eNB 12 and the UE 10 communicate over a wireless link 15, each using one or more antennas 12E, 10E. In an embodiment, the wireless link 15 is a downlink control channel such as PDCCH. At least one of the PROGs 10C and 12C is assumed to include program instructions that, when executed by the associated DP, enable the electronic device to operate in accordance with the exemplary embodiments of this invention, as will be discussed below in greater detail.

In general, the exemplary embodiments of this invention may be implemented by computer software executable by the DP 10A of the UE 10 and the other DPs, or by hardware, or by a combination of software and/or firmware and hardware.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B and 12B may be of any type suitable to the local technical environment and may be implemented using any suitable data storage technology, such as semiconductor-based memory devices, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multi-core processor architecture, as non-limiting examples.

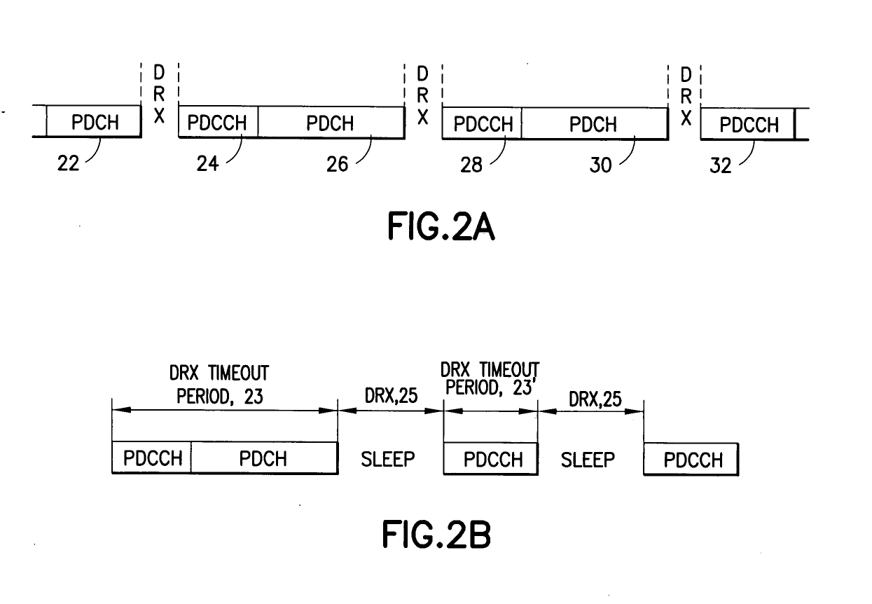

FIG. 2A shows a transmission where control (24) and data (26) alternate (DL). One duty cycle of control and data represents a TTI (or sub-frame). Normally when a UE is scheduled, the eNB sends control signaling on the PDCCH and if the UE is allocated on the data channel, then the eNB also sends data on the PDCH (DL-SCH). At a first data interval 22 the UE 10 may be sent data on the DL (or may send data on the UL), over a channel given by example as a packet data channel PDCH (which may be an uplink or downlink shared channel SCH). Subsequently is a second interval or control interval 24 during which time the UE 10 is expected to monitor a control channel, shown by example as PDCCH. This series repeats in the illustrated intervals for data 26 and 30 and for control information 28 and 32.

As context to the below description, FIG. 2B illustrates communications in several successive intervals according to a DRX regimen, shown from the UE perspective. Upon entry into the network 1, the UE 10 is given a DRX schedule (e.g., monitor PDCCH at intervals of 20 ms), until the UE's DRX schedule is changed by the network, such as when handed over to another eNB. Typically the UE is provided DRX parameters upon entry into the cell/network. The length of time during which the UE 10 is instructed/expected to monitor the control channel is termed herein the DRX timeout period 23. The length of time between DRX timeout periods 23 is termed herein the DRX 25 (consistent with 3GPP TS 36.300 at Appendix A). In the event a UE 10 receives the PDCCH during the DRX timeout period and is not allocated (assuming dynamic allocation), it may enter a sleep mode for the duration of the DRX and awake for the next DRX timeout period to check if it is allocated there. If the UE is allocated, it only need monitor (or send on the UL) that portion of the data interval for which the allocation is valid. The length of the DRX and the DRX timeout period may be set by the network 1, and relevant to the embodiments below the DRX timeout period may be dynamically adjusted in the network based on data traffic and number of UEs being served at once. The DRX timeout period is also sometimes referred to as a duty cycle, the length of the ‘reception window’ per DRX. For example, a duty cycle of 2 means the UE 10 receives two successive AT/PDCCHs per DRX [in current practice one AT/PDCCH spans one TTI (or sub-frame) (1 ms) or two slots (each 0.5 ms)]. A typical DRX for VoIP implementations is 20 ms minus the DRX timeout period.

In dynamic scheduling according to the prior art, the UE 10 is authorized by the network 1, on the PDCCH 24 during a DRX timeout period 23, a resource allocation by which it is to receive data (or to transmit its data) during the next data interval PDCH 26. That resource allocation is valid only for the data interval following the DRX timeout period in which the allocation was received. Multiple UEs may be allocated in the same DRX timeout period 23 different allocations for the same data interval, but the resources allocated are unique so that packets/transmissions directed to or sent from different ones of those multiple allocated UEs do not interfere with one another though received/sent in the same data interval 26. Each resource allocation identifies the UE to which it is intended, such as through a c-RNTI (radio network temporary identifier) or other identifier unique in the cell, so the same PDCCH can be shared by the multiple UEs. Recall that this is the genesis of the problem, the size of the PDCCH may not be sufficient to allow all resources to be allocated to the multiple UEs.

Embodiments of this invention use a semi-persistent resource allocation, in which a resource allocation received in a DRX timeout period remains valid for more than data interval. In that respect it is persistent. But in this invention's embodiments, the persistent allocation is partly defined via the DRX parameters, so it is in effect also semi-dynamic. The UE 10 stores the latest valid received resource allocation and based on the DRX parameters uses this allocation as a default allocation until a new valid persistent allocation is received. The UE then overwrites the former stored persistent configuration with the newly received persistent resource allocation, which then becomes the new default persistent allocation.

At least two alternatives exist. In a first alternative the network configures the UE 10 during the connection setup to store, as a persistent allocation, any resource allocation configuration that addresses the UE that is in the first TTI of a DRX timeout period. If for example the DRX timeout period is longer than one TTI, then any additional resource allocations the UE 10 receives in other TTIs of the same DRX timeout period are not necessarily persistent; in embodiments they may be true dynamic. From the connection setup signaling the UE 10 knows that all resource allocations for it that are within the first TTI of a DRX timeout period are to be persistent allocations. Assume the DL scenario for a simple example. The UE receives on the PDCCH during the first TTI of a first DRX timeout period a DL allocation. The UE 10 stores that allocation in its MEM 10B, tunes-its transceiver 10D to receive according to that stored allocation (which is a persistent allocation), receives data, tunes back to the PDCCH during the next DRX timeout period to check for any new DL allocation. If the UE is not addressed in that new AT of the next DRX timeout period, it again tunes its transceiver 10D in the next duty cycle to receive according to the same stored DL allocation and again receives data.

In a second alternative the UE 10 only stores, as a persistent allocation, the resource allocation configuration when the network indicates (in signaling with the allocation) that this allocation is a persistent allocation. Any resource allocation received that does not have this additional indication by the network is deemed by the UE 10 to be a dynamic allocation. Assume the DL scenario for a simple example. The UE receives on the PDCCH during a DRX timeout period a first DL allocation. Assume that this first DL allocation includes the persistence indicator. The UE 10 tunes its transceiver 10D to receive in the next data interval according to the first DL allocation, receives data, tunes back to the PDCCH to check for any new DL allocation during the (same or next) DRX timeout period, and receives a new DL allocation that lacks the persistence indicator. The UE 10 does not overwrite the stored persistent DL allocation configuration, but instead considers that it now has a dynamic (one time) DL allocation so in the next data interval tunes its transceiver to receive according to the new DL allocation. Lacking another allocation that addresses the UE in that next subsequent DRX timeout period, the UE again tunes its transceiver 10D to receive according to the originally stored DL allocation in the next subsequent data interval and again receives data. Detailed below is the fact that the length of the C-RNTI is to be increased in E-UTRAN, which makes many more C-RNTI values available for use. In an embodiment, a specific C-RNTI or other temporary identifier assigned by the network to the UE can be used to indicate a persistent allocation. In this embodiment, the UE is given at least two C-RNTIs. When the UE reads a first one of them in the PDCCH, it is an indicator that the allocation associated with that first C-RNTI is dynamic and non-persistent, and when it reads the other it is an indication that the allocation associated with that second C-RNTI is persistent. The network can also assign three or more C-RNTIs to a single UE, where two (or more) of them indicate allocations of different persistence (e.g., one indicating that the associated allocation is persistent until overwritten or handover to another cell, another indicating that the associated allocation is persistent for 2 or 3 or some specific number of duty cycles). The different persistences for the individual C-RNTIs can be agreed upon at connection setup when the C-RNTIs are assigned (and stored in memory), or alternatively a persistence-duration indicator can be used in the PDCCH the first time the network uses a particular C-RNTI for a particular UE, and the network and UE know (store the association in memory) that a particular C-RNTI will always be associated with the indicated persistence-duration (for as long as the C-RNTI is assigned to that UE in the cell). Where multiple C-RNTIs are used for different persistences that are not agreed at connection setup, the used C-RNTI itself will of course indicate persistent versus non-persistent allocation, and a stolen CRC bit (detailed below) can be used as the persistence-duration indicator.

One embodiment as to how the allocation might be indicated by the network as a persistent allocation is ‘stealing’ one of the CRC bits of the CRC field as described in a U.S. provisional patent application Ser. No. 60/919,056 filed on Mar. 20, 2007 and entitled “APPARATUS, METHOD AND COMPUTER PROGRAM PROVIDING CYCLIC REDUNDANCY CHECK PROTECTION OF CONTROL CHANNELS” by inventors Frank Frederiksen and Troels Kolding (hereby incorporated by reference in its entirety). In such a bit-stealing scenario, the bit is stolen from the CRC field of the resource allocation for that UE 10 that is sent in the DRX timeout period. As noted in that application, there is a slightly increased error rate by the loss of a bit from the CRC field for forward error control. There is an additional concern for increased error rate in the UE properly decoding its C-RNTI used to identify the UE for the allocation. This is because the C-RNTI is used to mask the CRC bits of that field. At least in E-UTRAN this concern is mitigated because the CRC field is expected to be extended from 16 to 24 bits and the stolen bit can be one other than those masked by the 16-bit C-RNTI.

As can be seen, the above embodiments provide an indicator that informs whether a particular resource allocation is persistent. In one embodiment the indicator is implicit in the position (TTI) of the DRX timeout period at which the allocation that addresses the UE 10 is disposed, and the relevant position is known by the eNB 12 and the UE 10 from connection setup signaling. In the other embodiment the indicator is explicit and in the same message with the allocation itself, whether as a bit stolen from the CRC field or some other explicit signaling mechanism.

It is noted that the UE 10 will at every occurrence of a DRX timeout period read the AT/PDCCH. Two cases may then occur (assuming there is only one TTI in the DRX timeout period):
a) If the UE 10 is addressed (reads its identifier) in the AT/PDCCH it will use the resource allocation, receive the data accordingly and store the resource allocation description for future use.
b) If the UE 10 is not addressed in the AT/PDCCH it will use a previously stored resource allocation—if one is available. The UE 10 will decode the DL data according to the stored resource allocation even though it was not given an allocation in the most recent DRX timeout period. The same concept also applies for the UL where the resource allocation grants the UE 10 permission to transmit on the granted resources.

Following is a more detailed description of the functionality for this scheduling concept. First are described some exemplary rules and/or constraints. These are described for simplicity in the context of an allocation for data to be received on the downlink DL, recognizing that similar functionality may be used for allocating transmit resource to the UE 10 for the uplink UL, or on both DL and UL.

The persistent allocation is linked to the DRX timeout period as follows:
a) The UE 10 is configured to use a specific DRX schedule/duty cycle using DRX parameters as is normally done, via signaling at initial connection setup.
b) If the eNB 12 elects to give a persistent allocation to a UE, in one embodiment that persistent allocation shall be sent to the UE in the first TTI (or other pre-designated TTI position) of the DRX timeout period. In an alternative embodiment, the network indicates explicitly which allocation configuration that the UE shall store as a persistent allocation configuration.
c) The relationship of persistent allocation to DRX schedule is independent of whether an allocation is valid or not. That is to say, when a UE 10 receives a new persistent allocation but it fails the CRC decoding, the UE 10 still considers that new persistent allocation as replacing any former persistent allocation, which is then overwritten by the new one. This seeming anomaly is addressed below, but is an advantageous approach to resolve the case where the allocation was corrupted in the air interface medium but the network considers those resources allocated. Alternatively, if the CRC decoding fails (either due to errors or due to wrong UE id), the UE will not replace the former persistent allocation.

First consider the case where there is only one TTI in a DRX timeout period:
a) The use of semi-dynamic persistent (SDP) allocation is configured by the eNB 12 (e.g. during connection setup using RRC signaling) together with other parameters like the DRX timeout period.
b) The UE 10 will store the latest received/given resource allocation and use this resource allocation as a default resource allocation during following scheduling occurrences (DRX timeout periods), since there is only one TTI in the DRX timeout period.
   i. The DL and UL allocations may be bundled or treated separately.
   ii. Separate treatment is seen to be more resource efficient in that there would be a further decrease in scheduling control overhead and independent control of UL and DL (e.g. for the VoIP case).
   c) If the network elects to stop scheduling the UE for transmissions in the UL, data reception in the DL, or both, there are several options to do so:
   i. The network can send an empty allocation to the UE. Once concern is that this requires additional L1/L2 control channel usage, which is an issue that this invention generally seeks to reduce. This option would ‘give back’ some of the reductions achieved by the persistent allocation above.
   ii. The network can send an ‘end-bit’ indication. The ‘end-bit’ could be sent on a data channel (e.g. MAC C-PDU) according to the UE's stored persistent allocation, so the UE 10 will already be monitoring when it is sent. Setting of the ‘end-bit’ could simply be based on the whether there is no more data to be transmitted to that UE. In the DL the network is in control of setting this ‘end-bit’, when its buffers for that UE are empty. In the UL the UE 10 could indicate an ‘end-bit’ for a given allocation once its buffers for data to be sent are empty. Alternatively, the network can control the UL based on the UE buffer status report information that the network receives.
   iii. The eNB does not schedule the UE 10 in a DL allocation but the persistent allocation expires in the absence of explicit signaling. This option is further detailed below.

Now consider the case where the network configures the DRX in such a way that the UE 10 shall receive more than one TTI/PDCCH per DRX timeout period. In this case UE 10 will receive a given number of TTI's in a continuous manner at each occurrence of the DRX timeout period. The UE knows frame number and TTI so can readily distinguish one from another.

In this multi-TTI case, the semi-dynamic persistent allocation is always placed in the same TTI of the DRX timeout period, for simplicity as the first TTI of the DRX timeout period. This designated TTI may be arranged between the eNB 12 and the UE 10 on initial connection setup, or whenever the DRX timeout period is changed when that parameter is dynamically configurable by the network. Of course, which TTI that is used for allocating the persistent allocation need not necessarily be agreed beforehand (e.g., when configuring the other parameters of the persistent allocation) but can be simply deducted by the UE 10 when receiving the first allocation for the persistent allocation. In the absence of some explicit arrangement between eNB 12 and UE 10, the first TTI of the DRX timeout period may be used as a default. Assume for this example that this default is the case.

The UE 10 will only try to read the stored persistent resource allocation from the first TTI—not any of the following TTI's of the same DRX timeout period. If the UE 10 does not read its identifier in the first TTI, and/or is not allocated in the stored persistent allocation that it previously received, the UE 10 will then read the AT/PDCCH of the following TTI's of the DRX timeout period. In an alternative embodiment, the UE 10 will always read the AT/PDCCH of the TTI's in addition to the first TTI in case the network allocated further resources to UE. This could be an optional configuration parameter if needed, and those other resource allocations in other than the first/designated TTI can be dynamic allocations or a persistent allocation, such as with the persistence indicator noted above. The choice may be set as a default or arranged during connection setup.

Consider an example within the case where the DRX timeout period spans multiple TTIs, and where no explicit network indication of persistent allocation is used.
a) If a pre-defined allocation for some reason cannot be scheduled in the first defined TTI of the DRX timeout period, the UE 10 will recognize this because the UE is not addressed in the AT of the first TTI of the DRX timeout period, and because decoding of received downlink data using a previously-stored persistent resource allocation will give a CRC failure.
b) In that event, the UE 10 then stores that downlink data, which the UE 10 received according to the previously-stored persistent allocation and failed to properly decode, for possible HARQ repetition.
c) The UE 10 will then read the next/following AT(s)/PDCCH(s) in the next TTI (as defined during connection setup) to see if it is allocated any resources.
d) If the UE 10 is addressed in an AT of any TTI other than the first TTI of the DRX timeout period, then two options are possible:
   i. The UE 10 will not change the stored default allocation (this is the simplest option) and this other allocation is deemed to be dynamic, or
   ii. The UE 10 will use this new resource allocation as the default (persistent) allocation in the future, until changed.
e) If the UE 10 did not get the correct CRC in the pre-defined downlink data (scheduling block) and the UE 10 was not scheduled in the AT of the first defined TTI of the DRX timeout period, the UE 10 will not send an ACK message for this data (see above, CRC failed). The network/eNB 12 will then know from the presence or absence of the ACK from the UE 10 whether to re-transmit the data of that scheduling block or not. The network retransmits the block due to the absence of an ACK, the UE 10 reads the HARQ re-transmission AT/PDCCH. In this embodiment a HARQ of an AT/PDCCH is interpreted as always scheduled (meaning the UE 10 is addressed in the AT/PDCCH), so the UE 10 will know the status (in this case that it was to be scheduled in the AT of the first defined TTI of the DRX timeout period) and it stores that allocation as a persistent allocation based on receipt of the re-transmission following the UE's failure to send an ACK. In this case using Synchronous HARQ or semi-Asynchronous HARQ would be simple implementations.

An alternative to the above is that the network/eNB 12 specifically indicates to the UE 10 which configuration the UE shall store. This approach has the benefit of allowing for more scheduling freedom on the network side while still being able to support the broader aspects of the invention. In this case the network/eNB 12 would indicate to UE 10 which one of potentially multiple sets of configurations the UE 10 shall store and re-use as its default allocation/configuration in the future. This assumes the UE 10 has stored locally a plurality of possible configurations, and the eNB 12 merely needs to signal which of those archived configurations is to be considered as default. The network/eNB 12 can then choose to use any configuration to send to the UE 10 during any AT/PDCCH that addresses the UE during the normal DRX timeout period.

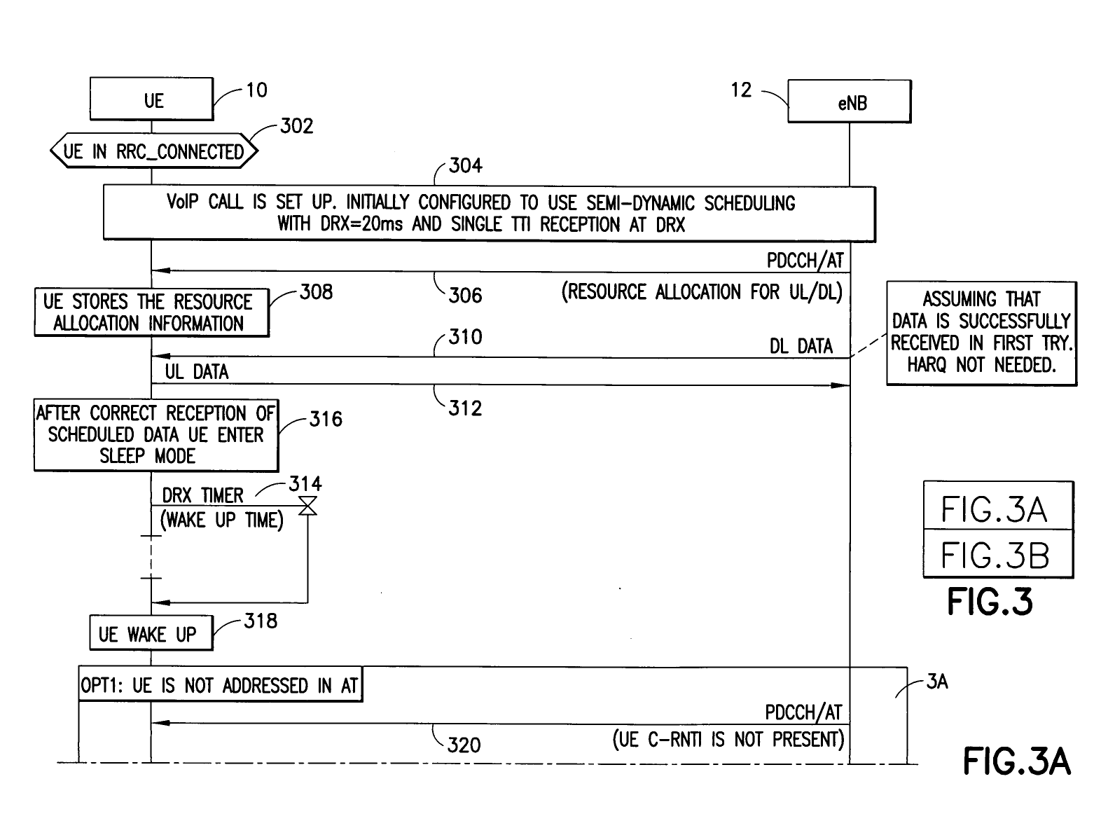

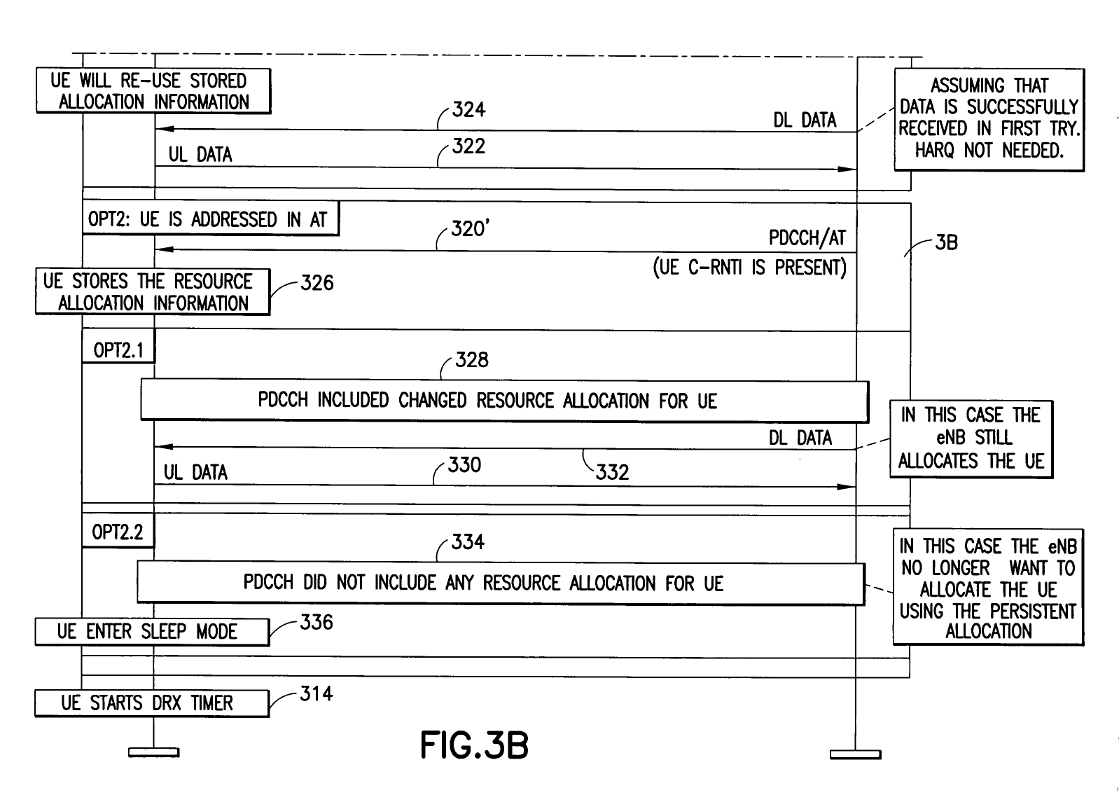

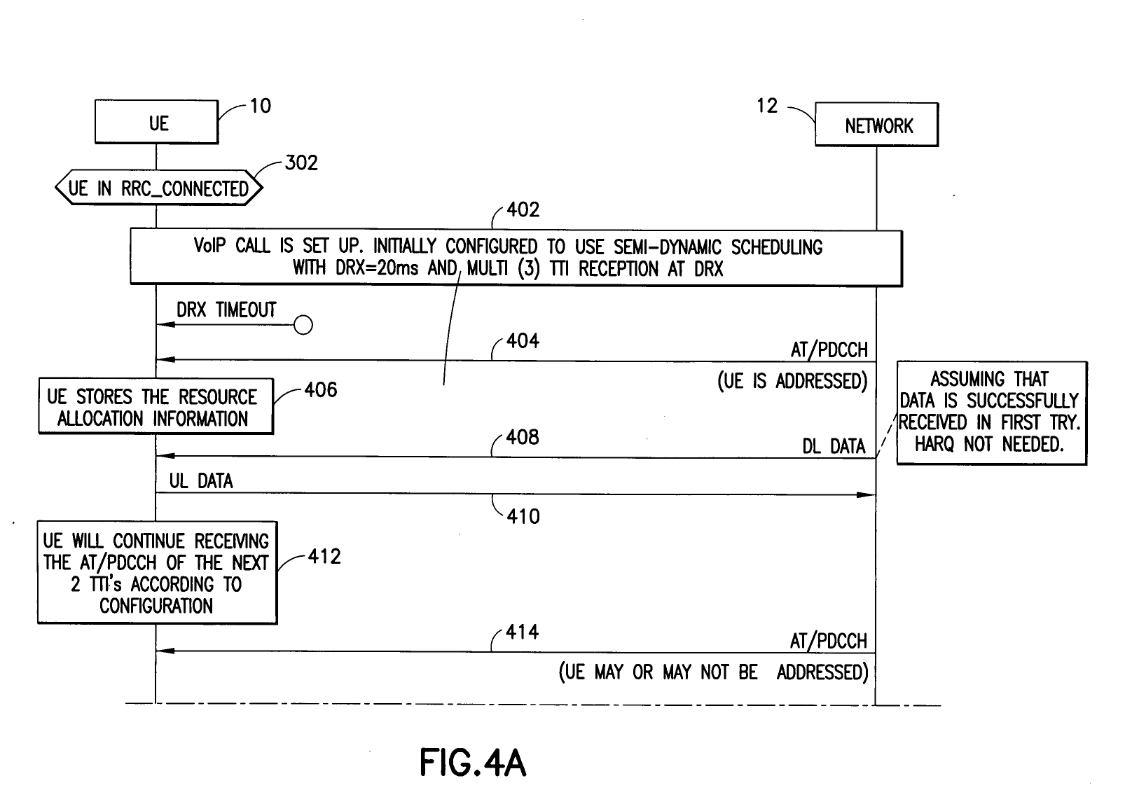

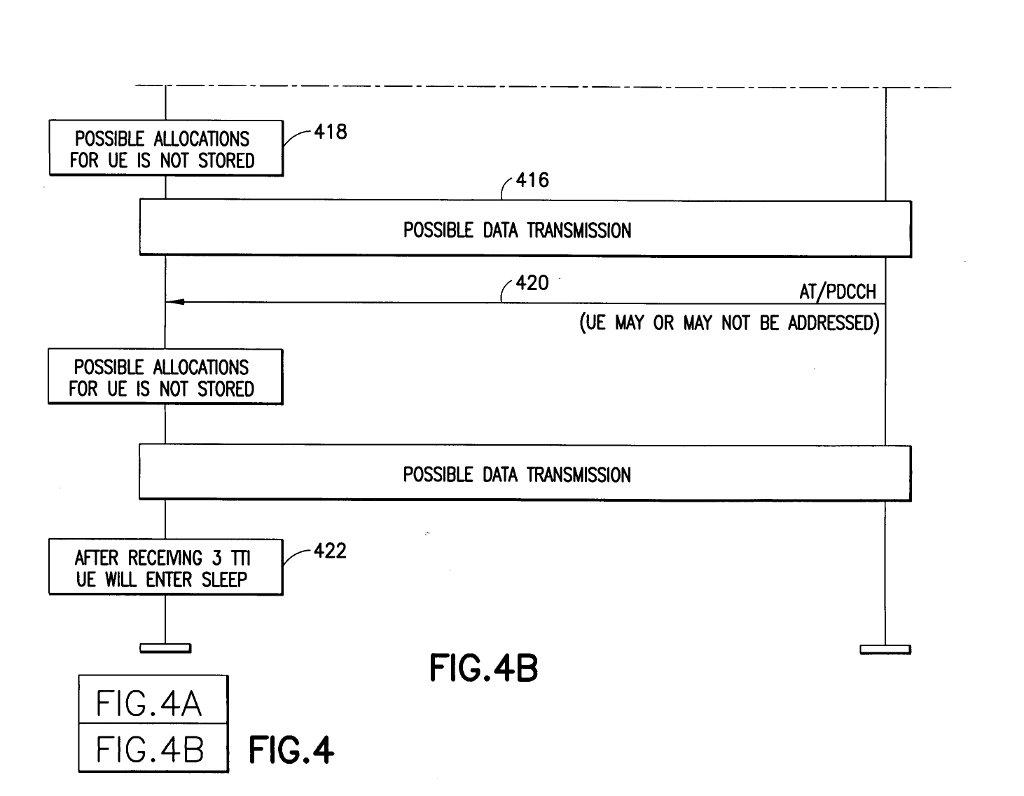

The above various embodiments and variations are distinguished from one another in the signaling diagrams of FIGS. 3-4. FIG. 3 illustrates the simple case of one TTI in the DRX timeout period and shows signaling between the eNB 12 and the UE 10. Connection setup is established at 302. A new call is setup at 304, a VoIP call. The eNB 12 decides to use semi-dynamic scheduling with DRX=20 ms and a single TTI in the DRX timeout period, and signals the UE 10 that additional setup information. Now at 306 comes the first DRX timeout period, during which the eNB 12 sends an AT over the PDCCH which includes a DL and/or an UL allocation for the UE 10. There is only one TTI, so the UE 10 stores this allocation configuration at 308. The UE 10 tunes to receive downlink data 310 according to that stored persistent allocation 308, and/or also sends its own uplink data 312 according to that same stored allocation 308 (since this is both a DL and UL allocation). Once both DL and UL is complete according to the stored allocation configuration, the UE 10 sets its DRX timer 314 (e.g., clock internal to the DP 10A) for the start of the next DRX timeout period (the remainder of the DRX) and enters sleep mode 316 (a powered down but not powered off state, for battery conservation). The UE 10 then wakes up 318 in time for the next DRX timeout period to see if there is a new AT.

At option 3A, assume the new AT 320 at the next DRX timeout does not address the UE 10 in that the UE 10 receives the new AT but cannot find its C-RNTI there. If the UE 10 has any data to send on the UL 322, it sends it using the stored allocation 308. Since this can be a joint DL and UL allocation, the UE 10 also may tune to receive any data on the DL 324 using that same stored allocation 308.

At option 3B, assume the new AT 320′ at the next DRX timeout period does address the UE 10. The UE 10 then overwrites the former stored allocation 308 with the new allocation 326. Two options are possible thereafter. If the new AT 320′ included a changed resource allocation 328 for the UE 10, then the UE 10 sends 330 and/or receives 332 according to that changed resource allocation 328 which is within the stored new allocation 326. If instead the new AT 320′ did not include any resource allocation 334 for the UE 10, then the UE 10 is not allocated any resources and enters sleep mode 336 and sets its DRX timer 314 to expire at the start of the next DRX timeout period. This is an alternative to end the persistent allocation (an empty ‘persistent’ allocation).

FIG. 4 is like FIG. 3, but for the case where the DRX is setup 402 for multiple (3) TTIs in the DRX timeout period. In the first TTI of the DRX timeout period the AT addresses the UE 10 with an allocation for DL and/or UL. The UE 10 stores 406 that allocation as it recognizes it as being a persistent allocation, and receives DL data 408 and/or sends UL data 410 according to that stored allocation. As noted above, the UE 10 can either ignore or receive the remaining TTIs of the same DRX timeout period as agreed on setup. Assume it is to monitor those additional TTIs 412. In the second TTI of the same DRX timeout period, there is another AT/PDCCH 414. If the UE 10 is allocated, it treats this as a dynamic allocation and transmits/receives appropriately 416, but does not store 418 this allocation as a persistent one and does not overwrite the allocation received in the first TTI 404. The same flow is followed for the third TTI 420 of that same DRX timeout period. After receiving the three TTIs and sending/receiving according to those allocations, the UE 10 sets its timer and enters sleep mode 422 until the next DRX timeout period.

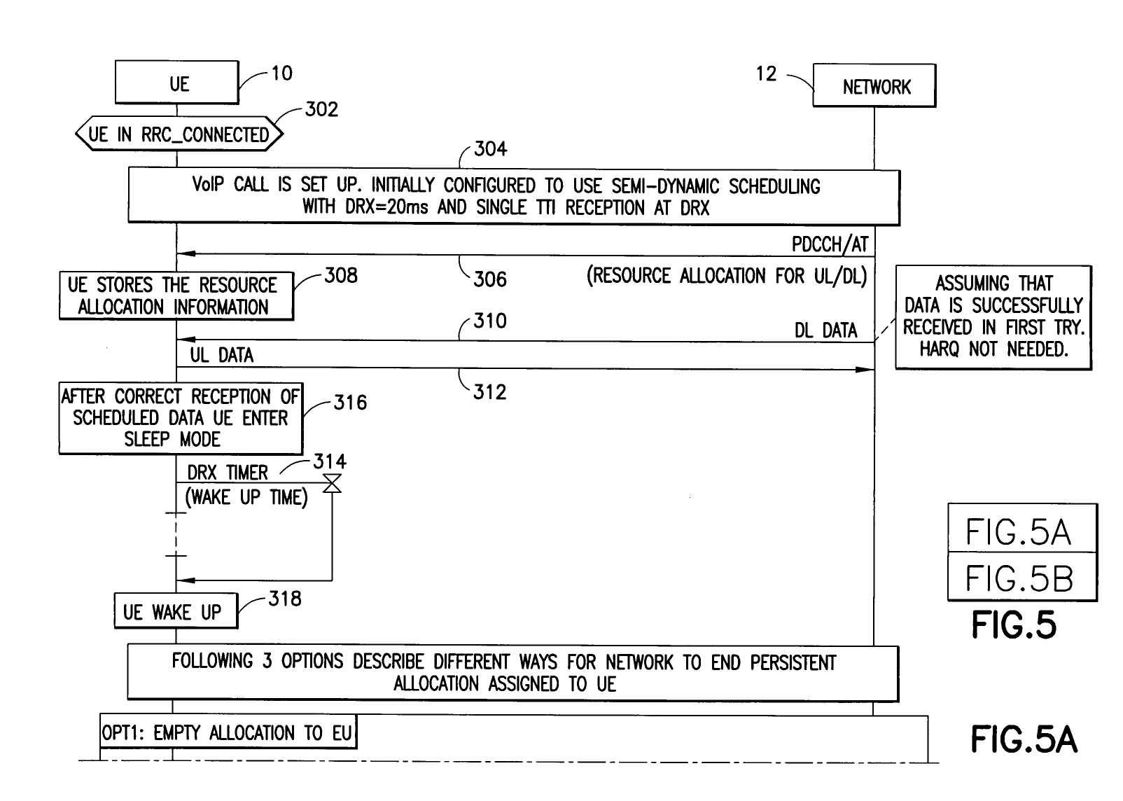

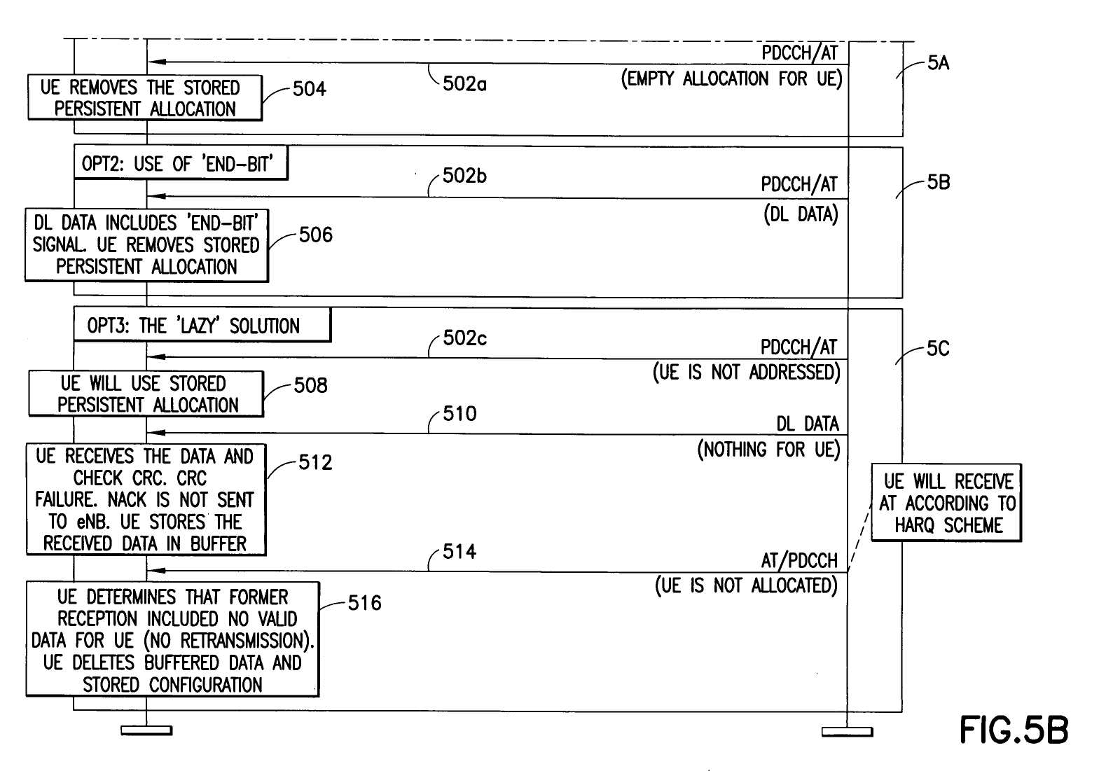

FIGS. 5-7 are signaling diagrams illustrating how a persistent allocation might be terminated apart from being replaced by another persistent allocation. FIG. 5 illustrates the scenario where the DRX timeout period is one TTI. Elements numbered as those in FIG. 3 are similar and not detailed further. Three options are shown to end a persistent allocation.

At option 5A is shown the empty allocation. The eNB 12 sends a AT/PDCCH 502a to the UE 10 during the TTI of a DRX timeout period that addresses the UE 10 but has an empty allocation for it. The UE 10 replaces 504 the stored persistent allocation with this one, since the UE is addressed in it. Since this new stored allocation is empty, the persistent allocation is effectively terminated. At option 5B is shown the ‘end-bit’ solution. The eNB 12 sends some kind of DL data 502b to the UE 10 according to the persistent allocation already stored at the UE 10, or sends an AT/PDCCH during the TTI of a DRX timeout period. In either case, the message to the UE 10 carries the ‘end-bit’. The UE 10 removes 506 the stored persistent allocation.

At option 5C is another approach to terminate the persistent allocation, termed for conciseness a ‘lazy’ solution because it is seen as fairly passive compared to the others. The eNB 12 may send a AT/PDCCH 502c to some other UE during the TTI of a DRX timeout period and thus does not address the UE 10 having the persistent allocation. The UE 10 therefore continues to use the stored persistent allocation 508 it received previously, and may see that there is no data 510 sent from the eNB 12 on the scheduled persistent DL resources. The data that is present on that DL resource the UE 10 attempts to decode but can't because the CRC fails, as expected because the data is not for that UE 10. The policy for this ‘lazy’ solution is that where the UE 10 uses a persistent allocation and finds no data as expected or data that it cannot decode, store the data but do not send a NACK. (When the eNB has not stopped transmitting to the UE, and if data was sent to that UE, but the UE failed to decode it correctly, the eNB 12 will recognize that it did not receive an ACK message, will consider the missing ACK as a NACK, and re-transmit the data. Re-transmissions are UE addressed (an AT is used 514) and thereby the UE 10 can see if the persistent allocation had any data for the UE 10 and uses this data (if present) together with the HARQ re-transmitted data.) Here, it is assumed that eNB does not send anymore data to the UE 10 (but the UE does not yet know it), UE tries to decode the AT/PDCCH for the retransmission. As seen at option 5C, the UE 10 received the AT/PDCCH 514 for the re-transmission, but the UE is not allocated in it. From that lack of allocation, the UE 10 concludes that the stored and undecoded packet was not for it, deletes the stored data packet(s), and also deletes the stored persistent configuration 516. At this point the UE 10 has no stored persistent allocation. The UE sets its DRX timer, enters sleep mode, and awakes to listen to the next DRX timeout period, seeking a new AT/PDCCH in which it is scheduled or only addressed. Alternatively, UE 10 may wait and receive two or more retransmission ‘attempts’ before it deletes the stored persistent configuration.

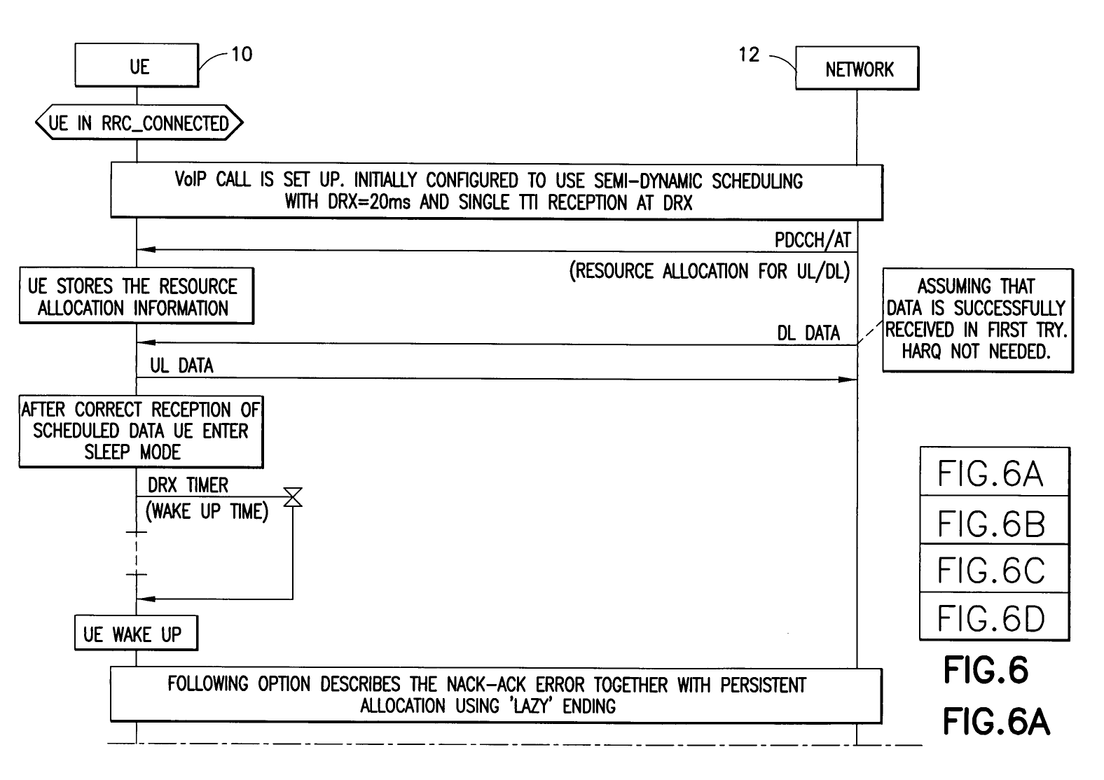

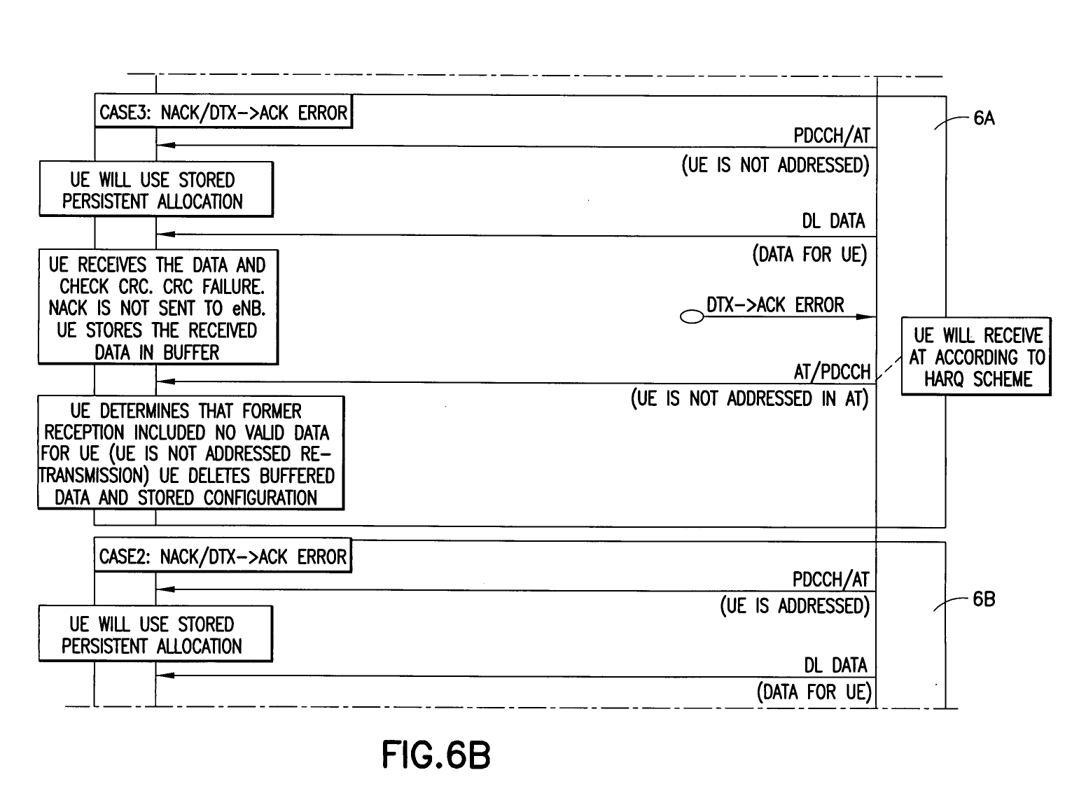

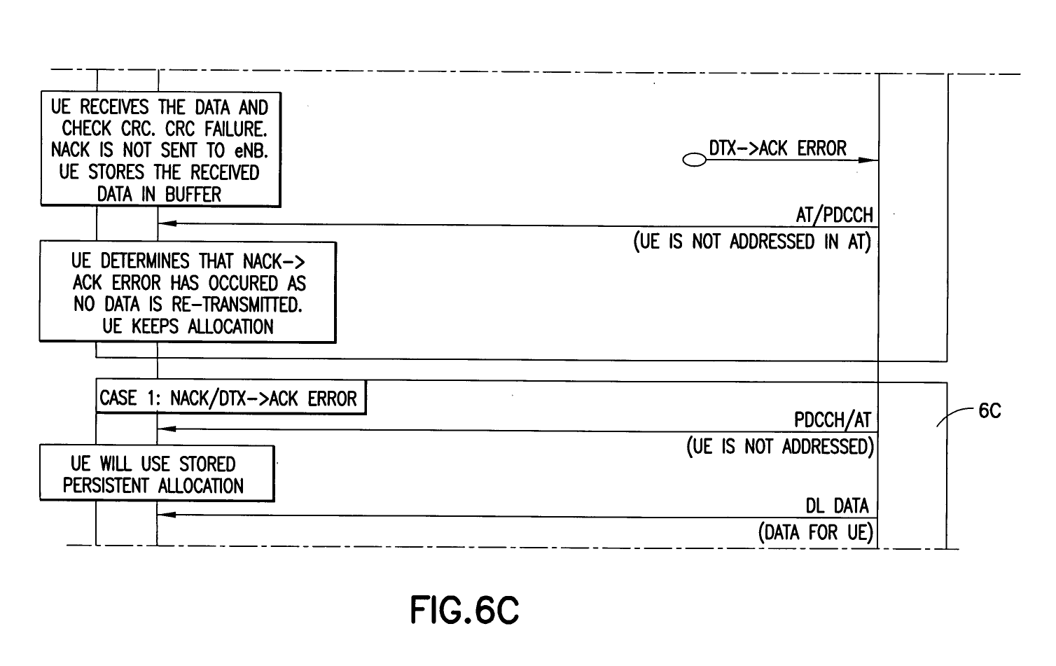

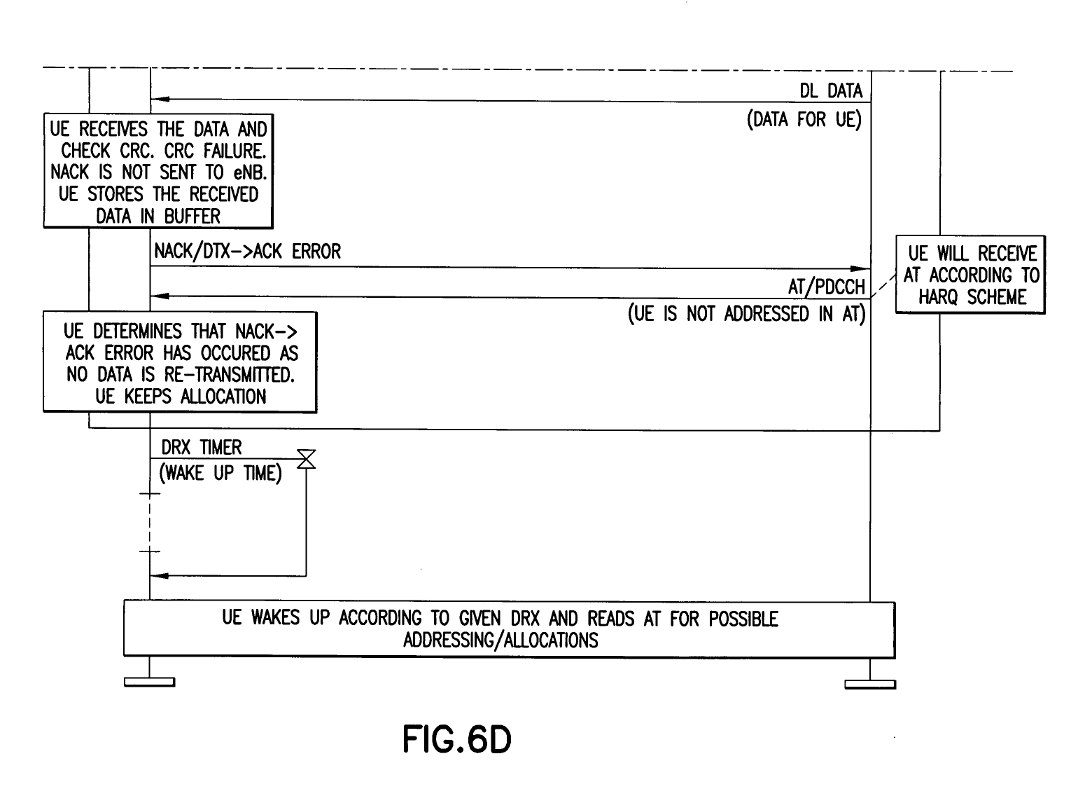

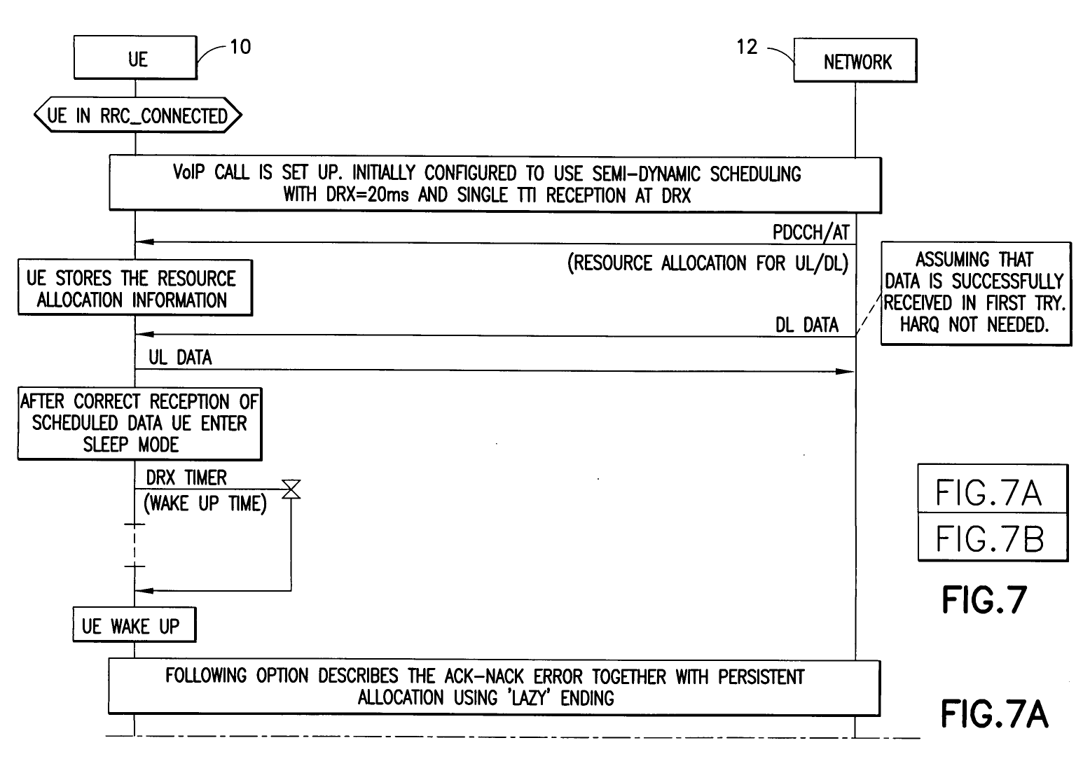

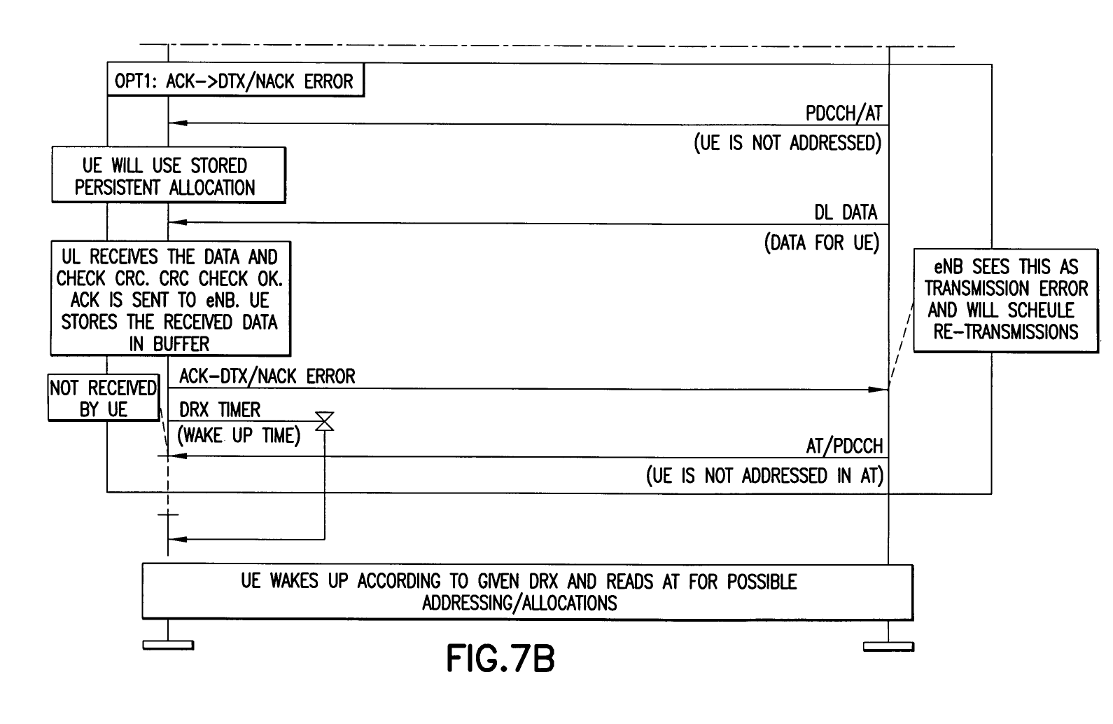

There are several implementations of the ‘lazy’ ending of a persistent allocation, shown in further detail at FIGS. 6-7. The lazy ending is based on the idea that the UE has been assigned a persistent allocation and thereby has knowledge about when it is supposed to receive data according to this prior given persistent allocation (on the allocated PRB physical resource block). If the UE 10 is not allocated (i.e., not receiving data) in the persistent allocation as it has been assigned by the eNB 12, the UE 10 will autonomously release the persistent allocation based on the result of the missing HARQ re-transmissions.

As a preliminary rule, assume that the UE 10 will not send NACK in the UL for data that the UE 10 determines might be wrongly received. This means that the UE 10 will not send a NACK message in the case where the CRC check fails for reception of the data according to the persistent allocation. Only an ACK message will be sent for the case where received data is successfully decoded (e.g., the CRC check is ok).

This option (not using NACK) and the information that the current connection is using a persistent allocation with the ‘lazy’ ending feature are all parameters that are controlled by the eNB 12 and given/commanded to UE 10 during the connection setup phase (possibly using RRC signalling).

The UE 10 performs a CRC check of its received data. After performing the CRC check the UE 10 will only know if it was data intended for the UE 10 if the CRC check is correct. If the CRC check fails the UE 10 cannot know whether the received information was either wrongly received or not intended for the UE 10 (i.e. the UE was not scheduled at all but some other UE was scheduled instead). Therefore the UE 10 will store the received data that it could not decode for possible later re-transmission. This is consistent with persistent allocation and blind detection as currently practiced. Here the data CRC is assumed to be UE specific, e.g., masked with the UE id.

Now, if the CRC check failed the UE 10 does not send a NACK message. The eNB 12 expects an ACK message but does not receive one, and so performs re-transmission. In the case of corrupted data, the eNB 12 would re-transmit the data according to HARQ re-transmission rules (standard procedure). In the case the eNB 12 didn't schedule the UE, the re-transmission will not happen. This fact, together with the basic idea of persistent scheduling, is used as input for the ‘lazy’ release feature. The eNB 12 and the UE 10 have a common understanding of the persistent allocation. For the case where the eNB 12 would like to release the persistent allocation used by the UE 10 it can simply just re-allocate the resources to another UE without notice to the currently assigned UE 10. The currently assigned UE 10 will see this as CRC check failure and try to receive the re-transmitted data.

The UE will try to receive the re-transmitted data by reading the AT/PDCCH according to HARQ re-transmission rules of the connection and search for its identification (e.g., C-RNTI). As the eNB 12 didn't schedule any data for the UE 10 in the first transmission, there is no data for the UE 10 in the re-transmission either. The UE 10 will see this as not being addressed in the AT/PDCCH of the re-transmission. After the UE 10 has recognized that it is not addressed for re-transmission it will release/delete the persistent allocation that it had previously stored. This is shown at option 5C of FIG. 5. As said earlier, alternatively, the UE may have to try and receive AT/PDCCH for several retransmissions before it releases the persistent allocation.

The ‘lazy’ release procedure is simplest if HARQ re-transmission(s) is (are) done using synchronous HARQ re-transmission. This is not a restriction though and asynchronous HARQ re-transmission work as well, at the cost of slightly increased complexity, power consumption and memory at the UE 10. The various HARQ processes are described at Appendix A: 3GPP TS 36.300 VL.0.0 (2007-03), E-UTRA and E-UTRAN Overall Description, Stage 2 (release 8). The ‘lazy’ release procedure is also readily adaptable to variations of synchronous or asynchronous HARQ as may be developed. Additionally the release of the persistent allocation may happen after one or more re-transmission test readings at the UE 10.

The following errors are possible in connection with this lazy ending feature:
Uplink ACK→NACK error: UL NACK is not used. The eNB may assume ACK was sent if receiving NACK feedback from the UE.
Uplink DTX→NACK error: UL NACK is not used. The eNB may assume ACK was sent if receiving ACK/NACK feedback from the UE. (See DTX→ACK).
Uplink NACK→ACK error: The UE will not transmit UL NACK. This case is similar as DTX→ACK error.
Uplink DTX→ACK error: This may happen and the DL data sent in the first transmission (new data) will be lost. This data loss would be handled through normal HARQ error procedures
Uplink ACK→DTX: This may happen. The eNB will read this as NACK. The eNB will assume transmission failure and re-transmit the data. The result will be wasted resources on re-transmissions.
Uplink NACK→DTX: This may also happen. The eNB will read this as NACK, which is correct.

Considering the two cases ACK→NACK and DTX→NACK these can be handled separately. As only the first case is a true error but the eNB 12 cannot distinguish the two cases, the eNB 12 can chose to interpret the NACK as either as an ACK or a NACK:
ACK: eNB will not re-transmit the data leading to packet loss in case of DTX→NACK. This then has to be handled e.g. through ARQ. ACK→NACK is handed correctly.
NACK: eNB will re-transmit the data. This will lead to wasted air interface resource in case of ACK→NACK. DTX→NACK is handled correctly.

So the eNB 12 can be configured to handle the above according to which one of the above is the most suitable. Note that there are no new errors introduced due to the ‘lazy’ release feature and the feature is not impacted by either of these two errors. The problematic cases are then DTX→ACK error and ACK→DTX error. These two cases are respectively illustrated in the signaling diagrams of FIG. 6 and FIG. 7.

From FIG. 6 (representing DTX→ACK error at option 6A; NACK→ACK error at option 6C; and DTX→ACK error at option 6B) the impact is that the UE 10 does not receive re-transmissions and will loose the packet. This situation is not new for a traditional HARQ procedure and could be handled through existing HARQ error handling. Three cases are seen to exist:
3)Option 6A: In this case the UE is able to detect the error if this scheme would include also NACK sending for erroneous packets (as the eNB will not re-transmit the data but re-transmission is expected by the UE). The NACK sending option is not seen as the most beneficial option but may best minimize this error situation.
2)Option 6B: If the UE has been addressed in the AT it can recognize that it should have received data (and did but the CRC check failed). Re-transmission should have happened but did not happen.
1)Option 6C: If the UE was not addressed in the AT and experienced a CRC check failure and no re-transmission happens, it will see this as ‘not scheduled’ and will release the persistent allocation.

If cases 1 or 2 above are seen by the UE, the UE will not release the persistent allocation and it will be maintained in the UE (so UE still has a stored allocation after this error). Therefore the UE will receive the next data transmission from the eNB using the stored persistent allocation. As for case 3 the UE will receive the AT according to the DRX timeout period.

From FIG. 7 (representing the ACK→DTX error) the eNB will see this as NACK response from UE (nothing sent). The eNB will schedule re-transmissions and these are wasted as the UE will not read/receive these. This will have no impact on the ‘lazy’ release of the persistent allocation as well, as the lazy ending feature has no impact on this type of HARQ error.

In the end the ‘lazy’ release feature is neutral with regard to HARQ ACK/NACK errors in the sense that it doesn't introduce any new error cases and is not impacted in functionality by these errors. The lazy release feature is advantageous in that it does not introduce new signaling to release a persistent allocation, and it is robust against HARQ errors.

Returning to the allocation rather than the releasing aspect of the invention, it is seen that the best approach would be that the persistent resource allocation would always be present in first TTI after the DRX timeout period if scheduled. This will reduce complexity on the UE side. This would mean no signaling but also less flexibility. Another alternative is that RRC signaling is used to tell in which TTI is used for allocating possible semi-dynamic persistent allocations.

Additional flexible resource allocations may be added. The single TTI case can be made flexible by allocating further resources to the UE using the normal AT/PDCCH procedure (no change to conventional procedures). The UE will store this new allocation as a default allocation. The network/eNB will have to configure the UE back to the original resource allocation if needed. The multi-TTI case can be handled as the single TTI case, but additionally the network/eNB may just allocate the additional resources in the following TTI's. This will not change the stored allocation and the network/eNB need not configure the UE back to original stored resource allocation. This would mean that the first TTI is always used for allocating stored (persistent) allocations and the other following TTI's can be used for additional resource allocations (as they will not be stored by UE). Alternatively, the network/eNB can indicate which of the multiple TTI's is used for giving allocation for storing.

Some further considerations concerning a bit for indicating whether an allocation is persistent or not. This could be an addition to AT/PDCCH, or smart coding (e.g., masking). The latter is viable in E-UTRAN once the CRC is set to 24 bits while the C-RNTI remains at 16 bits; the persistence indicating bit can mask one of the remaining 8 bits of the longer CRC that is not masked with the C-RNTI. Perhaps an additional bit can be used to mask another of those remaining 8 bits, where the additional bit indicates the time domain of the allocation. Alternatively, RRC signaling could tell the periodicity of the persistent allocation. However, either approach increases the complexity, at the gain of further flexibility for network. The use of semi-dynamic persistent allocation can also be configured using RRC signaling and simple rules as described above.

For the case where semi-dynamic persistent allocation is every 20 ms but DRX is a different period (e.g. 10 ms), the UE will need to know the time domain part of the stored allocation—the time distance between two occurrences (e.g., VoIP). Separate RRC signaling may be defined which tells in which TTI the semi-dynamic persistent allocation is valid to address this issue. DRX used by the UE can also be set to same time interval as the time interval between possible indications of stored (or to be stored) allocations. There would then be an additional need for DL capacity, which can be handled through other DRX means such as a keep-awake indicator to the UE.

If this semi-dynamic persistent allocation is considered in view of the full flexible approach and the current DRX concept, there may not be a need for timing constraints at all. Consider that the UE will always use the latest received allocation as default allocation whenever received. For example, assume the UE has VoIP ongoing but for some reason has DRX shorter than needed for VoIP (e.g. 10 ms due to other data). The UE will read the AT every 10 ms. If it is an allocation for data, then that allocation is stored and possibly re-used for coming data and no problem occurs. This introduces a possible gain in reduced AT use for the next packet. Otherwise, if there are no further packets for the UE, then the UE will at the next wake-up read the AT again. If the network/eNB sees a need to change the UE's allocation due to the VoIP packet it's now sending, then the system works as usual. In the worst case then the savings in AT are less than optimal but certainly much less complex than what we introduce above. There may be a need for additional LIE memory unless some sort of ‘end-bit’, maximum number of blank receptions, ‘empty-allocation’, or ‘lazy ending’ feature is used.

As can be seen, the advantages offered by embodiments of this invention include that it is applicable for both VoIP and non-VoIP data, no additional L1 signalling is needed, both single and multi-TTI is supported, it can be applied to UL and DL separately or bundled, it works with the current LTE design without changes to the basic signaling and operates similar to dynamic scheduling, and there is no blind decoding by the UE.

Further, while described in the context of LTE and downlink resource allocations, it is within the scope of the exemplary embodiments of this invention to use the above described UE 10 and eNB 12 procedures for any type of downlink shared control channel signaling as well as in other wireless communication systems such as GSM, UTRAN, CDMA, OFDM and the like. The various signaling diagrams are seen to represent method steps executed by the various depicted nodes, responsive to received signaling and actions shown in those diagrams, and also to illustrate specific functions for which the depicted hardware in FIG. 1 are configured to perform.

In general, the various embodiments may be implemented in hardware or special purpose circuits, software (computer readable instructions embodied on a computer readable medium), logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

We claim

1. A method comprising:
setting up a connection with an individual user equipment; and
sending resource allocations to a plurality of user equipments that comprises a particular resource allocation to the individual user equipment and an indication that the particular resource allocation is a persistent resource allocation.

2. The method of claim 1, wherein the indication is implicit in the position of the particular resource allocation to the individual user equipment in a packet data control channel.

3. The method of claim 2, wherein the position at which the indication is implicit is one of arranged with the individual user equipment when setting up the connection or made apparent to the user equipment from the particular resource allocation.

4. The method of claim 1, wherein the indication is explicit within the particular resource allocation to the individual user equipment that is sent with the resource allocations.

5. The method of claim 4, wherein the indication comprises at least one bit stolen from a cyclic redundancy check field associated with the particular resource allocation.

6. The method of claim 1, further comprising terminating the persistent resource allocation by sending an empty resource allocation to the individual user equipment.

7. The method of claim 1, further comprising terminating the persistent resource allocation by at least one of sending to the individual user equipment an end bit in a downlink resource that is allocated according to the persistent resource allocation, or receiving from the individual user equipment an end bit in an uplink resource that is allocated according to the persistent resource allocation.

8. The method of claim 1, wherein for the case wherein a discontinuous reception DRX timeout period of the individual user equipment spans more than one transmission time interval TTI, the persistent resource allocation is for a same designated TTI of consecutive DRX timeout periods.

9. The method of claim 8, wherein the same designated TTI is designated on at least one of setting up the connection or when the DRX timeout period for the individual user equipment is dynamically changed.

10. The method of claim 8, further comprising sending another resource allocation to the individual user equipment within a DRX timeout period in a TTI following the designated TTI only if it is arranged with the individual user equipment to monitor the TTI following the designated TTI by default or upon initial connection setup.

11. The method of claim 1, further comprising terminating the persistent resource allocation by sending to the individual user equipment in a downlink resource allocated by the persistent resource allocation at least one of no data or data with an associated cyclic redundancy check field that is improper, for the case where the persistent resource allocation is for downlink.

12. The method of claim 11, further comprising to not send a negative acknowledgement NACK message for the case where data received according to the persistent resource allocation fails a cyclic redundancy check.

13. The method of claim 12, further comprising, responsive to failing to receive an acknowledgement from the individual user equipment for receipt of the data with the improper cyclic redundancy check field, not re-transmitting the data with the improper associated cyclic redundancy check field to the individual user equipment to terminate the persistent resource allocation.

14. The method of claim 1, further comprising terminating the persistent resource allocation by not sending nor retransmitting to the individual user equipment in a downlink resource allocated by the persistent resource allocation.

15. An apparatus comprising a processor, a memory and a transceiver configured to set up a connection with an individual user equipment and to send resource allocations to a plurality of user equipments that comprises a particular resource allocation to the individual user equipment and an indication that the particular resource allocation is persistent.

16. A computer readable memory embodying a program of machine-readable instructions executable by a digital data processor to perform actions directed toward scheduling an individual user equipment for a persistent resource allocation, the actions comprising:
setting up a connection with an individual user equipment; and
sending resource allocations to a plurality of user equipments that comprises a particular resource allocation to the individual user equipment and an indication that the particular resource allocation is persistent.

17. A method comprising:
setting up a connection with a network element; and
receiving from the network element a particular resource allocation and an indication that the particular resource allocation is persistent and storing the persistent resource allocation.

18. The method of claim 17, wherein the indication is implicit in the position of the particular resource allocation within a plurality of resource allocations to a plurality of user equipments that is received in a packet data control channel.

19. The method of claim 18, wherein the position at which the indication is implicit is one of arranged with the network element when setting up the connection or deduced by the user equipment from the particular resource allocation.

20. The method of claim 17, wherein the indication is explicit within the particular resource allocation.

21. The method of claim 20, wherein the indication comprises at least one bit stolen from a cyclic redundancy check field of a resource allocation.

22. The method of claim 17, further comprising receiving an empty resource allocation from the network element to terminate the persistent resource allocation.

23. The method of claim 17, further comprising deleting the stored persistent resource allocation in response to at least one of receiving from the network element an end bit in a downlink resource that is allocated according to the persistent resource allocation, or sending to the network element an end bit in an uplink resource that is allocated according to the persistent resource allocation.

24. The method of claim 17, wherein for the case wherein a discontinuous reception DRX timeout period spans more than one transmission time interval TTI, the persistent resource allocation is for a same designated TTI of consecutive DRX timeout periods.

25. The method of claim 24, wherein the same designated TTI is designated on at least one of when the connection is setup or when a new DRX timeout period is received from the network element.

26. The method of claim 24, further comprising receiving another resource allocation from the network element within a DRX timeout period in a TTI following the designated TTI only if it is arranged with the network element to monitor the TTI following the designated TTI by default or when setting up the connection.

27. The method of claim 17, further comprising deleting the stored persistent resource allocation upon receiving in a downlink resource allocated by the persistent resource allocation at least one of no data or data that is improperly decoded using a cyclic redundancy check field associated with the data, for the case where the persistent resource allocation is for downlink.

28. The method of claim 27, further comprising to not send a negative acknowledgement NACK message for the case where data received according to the persistent resource allocation fails a cyclic redundancy check.

29. The method of claim 28, further comprising, not sending to the network element a negative acknowledgement for receipt of the data with the improper cyclic redundancy check field, and responsive to not receiving a re-transmission of the data that is decoded improperly, autonomously deleting the stored persistent resource allocation.

30. The method of claim 17, further comprising releasing the persistent resource allocation when not receiving correctly in a downlink resource allocated by the persistent resource allocation nor receiving a selected number of retransmissions.

31. An apparatus comprising a processor, a memory and a transceiver configured to set up a connection with a network element and receive from the network element a particular resource allocation and an indication that the particular resource allocation is persistent and to store the persistent resource allocation.

32. A computer readable memory embodying a program of machine-readable instructions executable by a digital data processor to perform actions directed toward determining that a resource allocation is persistent, the actions comprising:
setting up a connection with a network element; and
receiving from the network element a particular resource allocation and an indication that the particular resource allocation is persistent and storing the persistent resource allocation.
